(19) United States
(12) Patent Application Publication
(10) Pub. No.: US 2025/0162112 A1
(43) Pub. Date: May 22, 2025

(54) HANDHELD POWER TOOL AND ACCESSORY RECEPTACLE

(71) Applicant: Nanjing Chervon Industry Co., Ltd., Nanjing (CN)

(72) Inventors: Biao Zhang, Nanjing (CN); Hongtao Ke, Nanjing (CN)

(21) Appl. No.: 18/894,911

(22) Filed: Sep. 24, 2024

(30) Foreign Application Priority Data
Nov. 21, 2023 (CN) 202311561120.4
Jul. 17, 2024 (CN) 202421691331.X
Jul. 17, 2024 (CN) 202421692606.1

(51) Int. Cl. B25B 21/00; A45F 5/02; B25F 5/02

(52) U.S. Cl. CPC B25B 21/00; A45F 5/021; B25F 5/029; A45F 5/1575

(57) ABSTRACT

A handheld power tool including an accessory receptacle. The accessory receptacle includes a receiving portion for receiving at least one accessory; a limiting portion for retaining the accessory in the receiving portion; an unlocking portion triggerable to drive the limiting portion to release a retaining force on the accessory; and a second cover forming an accommodation space with a first cover, where the accommodation space is configured to at least partially accommodate the receiving portion, the limiting portion, and the unlocking portion.

### RELATED APPLICATION INFORMATION

This application claims the benefit under 35 U.S.C. § 119 (a) of Chinese Patent Application No. 202311561120.4, filed on Nov. 21, 2023, Chinese Patent Application No. 202421691331.X, filed on Jul. 17, 2024, and Chinese Patent Application No. 202421692606.1, filed on Jul. 17, 2024, which applications are incorporated herein by reference in their entireties.

### TECHNICAL FIELD

The present application relates to a power tool and, in particular, to a handheld power tool and an accessory receptacle.

### BACKGROUND

Handheld power tools play a very important role in production as they can reduce labor intensity and improve working efficiency. When a user uses a handheld power tool, the handheld power tool is provided with accessories like a belt clip, and the accessories are fixed with screws so that the handheld power tool is hung on a belt or rope with the belt clip. These accessories are generally arranged on a side of the handheld power tool. Under some “edge-adjacent” working conditions where an obstacle exists on one side, the side where the accessories are located is difficult to be adjacent to the edge.

This part provides background information related to the present application, and the background information is not necessarily the existing art.

### SUMMARY

A handheld power tool includes a motor; an output portion driven by the motor to output power; a housing for accommodating the motor, where the housing includes a first housing extending substantially along a first axis and a first cover formed at or connected to an end of the first housing facing away from the output portion and extending along a direction intersecting the first axis; and an accessory receptacle for detachably connecting an accessory of the handheld power tool. The accessory receptacle includes a receiving portion for receiving at least one accessory; a limiting portion for retaining the accessory in the receiving portion; an unlocking portion triggerable to drive the limiting portion to release a retaining force on the accessory; and a second cover forming an accommodation space with the first cover, where the accommodation space is configured to at least partially accommodate the receiving portion, the limiting portion, and the unlocking portion.

In some examples, at least two receiving portions are provided.

In some examples, the unlocking portion includes an operating member, and the operating member is formed on or connected to the limiting portion, is movably connected to the second cover, and at least partially extends out of the second cover.

In some examples, the unlocking portion further includes a reset member, and when the operating member is released, the reset member is able to drive the operating member to reset and provide the limiting portion with the retaining force for the limiting portion to retain the accessory.

In some examples, the accessory is driven to move in a preset direction and a first surface of the accessory pushes a second surface of the limiting portion so that the limiting portion moves in a direction to release the retaining force on the accessory.

In some examples, the accessory receptacle further includes a limiting pad configured to fill a gap between the accessory and one of the receiving portion or the limiting portion.

In some examples, the limiting portion extends or is embedded into the accessory to retain the accessory.

In some examples, the accessory includes a belt clip for hanging the handheld power tool.

In some examples, the accessory includes a belt clip and a storage member, and the storage member is a bit retaining structure.

In some examples, the accessory includes a first connector and a storage member, and the storage member is a container.

In some examples, an opening of the container always faces upwards.

In some examples, the container is rotatably disposed on the first connector, and the opening of the container always faces upwards under the action of gravity.

In some examples, the unlocking portion is connected to the limiting portion, and the unlocking portion rotates upon receiving a trigger force to drive the limiting portion to release the retaining force on the accessory.

In some examples, one unlocking portion is provided, the unlocking portion includes multiple positions for unlocking respective accessories, and the unlocking portion is operable to switch between the multiple positions to release the retaining force on a corresponding accessory.

In some examples, the limiting portion includes a limiting surface, the accessory includes a stop surface, and when the accessory is retained in the receiving portion, the limiting surface is in contact with the stop surface to prevent a displacement of the accessory along a first direction, where the angle α between a length extension direction of the stop surface and a second direction is less than or equal to 30°, the second direction is perpendicular to the first direction, and the second direction and the length extension direction of the stop surface are in the same plane.

A handheld power tool includes a motor; an output portion driven by the motor to output power; a housing including a first housing and a power connection portion, where the first housing accommodates at least the motor, the power connection portion receives at least part of a power supply, and the power supply supplies power to at least the motor; and an accessory receptacle for detachably connecting an accessory of the handheld power tool. The accessory receptacle includes a receiving portion for receiving at least one accessory of the handheld power tool; a limiting portion for retaining the accessory of the handheld power tool in the receiving portion; and a second cover fixed on the outer side of the housing by a fastener, where the second cover forms an accommodation space with the housing, and the accommodation space is configured to at least partially accommodate the receiving portion and the limiting portion.

An accessory receptacle for detachably connecting an accessory of a handheld power tool includes a receiving portion for receiving at least one accessory of the handheld power tool; a limiting portion for retaining the accessory in the receiving portion; an unlocking portion triggered to drive the limiting portion to release a retaining force on the accessory; a retaining cover formed on or connected to a housing of the handheld power tool; and a cover connected to the outer side of the retaining cover, where the cover forms an accommodation space with the retaining cover, and the accommodation space is configured to at least partially accommodate the receiving portion, the limiting portion, and the unlocking portion.

In some examples, the cover is connected to the retaining cover by a fastener.

In some examples, the unlocking portion is connected to the limiting portion, and the unlocking portion rotates upon receiving a trigger force to drive the limiting portion to release the retaining force on the accessory.

In some examples, the limiting portion includes a limiting surface, the accessory includes a stop surface, and when the accessory is retained in the receiving portion, the limiting surface is in contact with the stop surface to prevent a displacement of the accessory along a first direction, where the angle α between a length extension direction of the stop surface and a second direction is less than or equal to 30°, the second direction is perpendicular to the first direction, and the second direction and the length extension direction of the stop surface are in the same plane.

### BRIEF DESCRIPTION OF THE DRAWINGS

FIG. 1 is a schematic view of a handheld power tool.

FIG. 2 is a schematic view of a handheld power tool mounted with decorative covers.

FIG. 3 is a schematic view of a handheld power tool separated from decorative covers.

FIG. 4 is an exploded view of an accessory receptacle.

FIG. 5 is a schematic view of an accessory being mounted to a handheld power tool.

FIG. 6 is another schematic view of an accessory being mounted to a handheld power tool.

FIG. 7 is a schematic view of unlocking of an unlocking portion.

FIG. 8 is a cross-sectional view of a first cover and a second cover of a handheld power tool.

FIG. 9 is a schematic view of unlocking portions of a handheld power tool.

FIG. 10 is an exploded view of FIG. 9.

FIG. 11 is a schematic view of a container as a storage member of a handheld power tool.

FIG. 12 is an exploded view of FIG. 11.

FIG. 13 is a schematic view of a belt clip as an accessory of a handheld power tool.

FIG. 14 is a schematic view of a bit retaining structure as a storage member of a handheld power tool.

FIG. 15 is a schematic view of an accessory receptacle on the upper side of a housing of a handheld power tool.

FIG. 16 is a schematic view of an accessory receptacle on a power connection portion of a handheld power tool.

FIG. 17 is a schematic view of another handheld power tool.

FIG. 18 is a front view of an accessory receptacle of another handheld power tool.

FIG. 19 is a front view of an accessory receptacle of another handheld power tool with a second cover removed.

FIG. 20 is a schematic view of an accessory receptacle with an inserted accessory in another handheld power tool.

FIG. 21 is a schematic view of removal of an accessory in another handheld power tool.

FIG. 22 is a front view of an accessory receptacle with an inserted accessory in another handheld power tool.

FIG. 23 is a front view of an accessory of another handheld power tool.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

To clearly illustrate the technical solutions of the present application, an upper side, a lower side, a left side, and a right side are defined in the drawings of the specification.

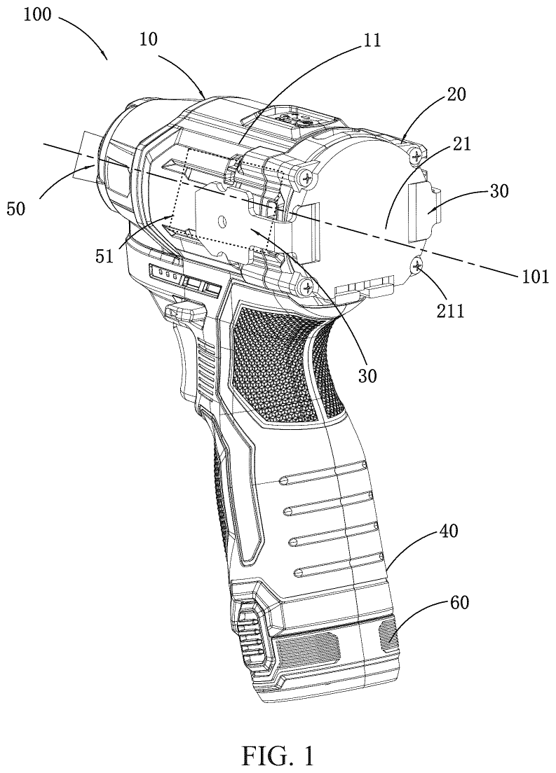

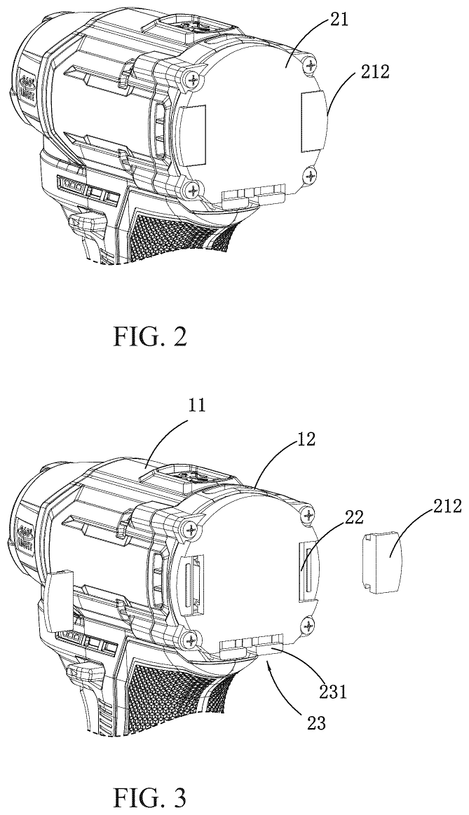

FIGS. 1 and 2 show a handheld power tool in an example of the present application. The handheld power tool plays a very important role in daily production and life. The handheld power tool includes, but is not limited to, an electric hand drill, an impact drill, an impact wrench, an impact screwdriver, and an angle grinder. The electric hand drill and the impact drill may be equipped with drill bits of different diameters to drill holes in objects. The impact wrench is used for tightening bolts and nuts. The impact screwdriver is usually used for loosening or tightening screws. The angle grinder can grind and cut objects. The handheld power tool can improve working efficiency and reduce labor intensity.

In this example, the handheld power tool is, for example, a gun-type tool such as a screwdriver 100. During use, the handheld power tool is configured with different execution components such as a drill bit, a grinding disc, a saw blade, and a sleeve to perform different tasks.

The screwdriver 100 includes a motor 51, an output portion 50, and a housing 10. In this example, the screwdriver 100 further includes a power supply for providing electrical energy for the screwdriver 100. In this example, the power supply is a direct current power supply. Optionally, the direct current power supply is a battery pack 60, and the battery pack 60 mates with a corresponding power supply circuit to supply power to the screwdriver 100. It is to be understood by those skilled in the art that the direct current power supply is not limited to the battery pack 60 and may be a built-in rechargeable battery or a standard battery. In other alternative examples, the screwdriver 100 may supply power to corresponding components in the screwdriver 100 through mains power or an alternating current power supply in conjunction with corresponding rectifier, filter, and voltage regulator circuits. For convenience of reference, the battery pack 60 is used instead of the direct current power supply in the following description, which is not to limit the present invention.

In some examples, the battery pack 60 may be a lithium battery pack, a solid-state battery pack, or a pouch battery pack. The nominal voltage of the battery pack 60 is higher than or equal to 10 V and lower than or equal to 80 V. Optionally, the nominal voltage of the battery pack 60 is higher than or equal to 10 V and lower than or equal to 48 V. The nominal voltage generally refers to a voltage specified by the manufacturer or the vendor on the label, packaging, user manual, specification, advertisement, marketing document, or another support document of the battery pack so that a user knows which power tools can run with the battery pack. Alternatively, the nominal voltage of the battery pack may be detected or calculated. The nominal voltage may be a voltage of the battery pack when the state of charge (SOC) of the battery pack is 50%.

In this example, the motor 51 includes a drive shaft rotating around a drive axis; the output portion 50 is driven by the motor 51 to output power; the housing 10 is used for accommodating the motor 51; and the housing 10 includes a first housing 11 and a first cover 12, where the first housing 11 extends substantially along a first axis 101, and the first cover 12 is formed at or connected to an end of the first housing 11 facing away from the output portion 50 and extends along a direction intersecting the first axis 101. In this example, the first cover 12 is a rear cover of the housing 10. The first housing 11 is divided into left and right parts and includes a left housing and a right housing, the left housing and the right housing are assembled to form an accommodation space whose rear portion is configured with an opening, and the first cover 12 is connected to the first housing 11 and covers the opening of the rear portion. In some examples, the first housing 11 is divided into the left and right parts and includes the left housing and the right housing, and the left housing and the right housing are configured with respective rear portions, that is to say, after the left housing and the right housing are assembled, the rear portion is closed. The first cover 12 is formed on the left housing and the right housing, that is to say, a rear wall portion of the left housing and a rear wall portion of the right housing constitute the first cover 12.

To easily carry the handheld power tool or to easily hang the handheld power tool on the body or on a fixed place when the handheld power tool is temporarily not used, the handheld power tool is equipped with accessories such as a belt clip. Moreover, in order that the user conveniently replaces an execution component when using multiple execution components, the handheld power tool is equipped with storable accessories to simultaneously retain the multiple execution components on the handheld power tool.

As shown in FIGS. 1, 3, and 4, the handheld power tool is further provided with an accessory receptacle 20. The accessory receptacle 20 is used for detachably connecting an accessory 30 of the handheld power tool. The accessory receptacle 20 includes a receiving portion 22, a limiting portion 24, an unlocking portion 23, and a second cover 21. The receiving portion 22 receives at least one accessory 30. The limiting portion 24 is used for retaining the accessory 30 in the receiving portion 22. The unlocking portion 23 is triggerable to drive the limiting portion 24 to release a retaining force on the accessory 30. The second cover 21 is connected to the outer side of the first housing 11, the second cover 21 forms an accommodation space with the first cover 12, the accommodation space is configured to at least partially accommodate the receiving portion 22, the limiting portion 24, and the unlocking portion 23, and the second cover 21 is formed on or connected to any one of the receiving portion 22 or the limiting portion 24.

In the related art, the accessory 30 is mounted to the handheld power tool with screws. When the accessory 30 is replaced or mounted, the user requires a special tool to mount and detach the accessory 30. Under an “edge-adjacent” working condition where an obstacle such as a wall exists on a side, the accessory 30 needs to be detached or relocated. In this case, the tool needs to be found for detaching and mounting the accessory 30, which is not conducive to the use of the user and reduces the working efficiency. In actual use, the accessory that is originally intended to facilitate the use of the user and improve user experience becomes a pain point. In this example, the triggerable unlocking portion 23 is provided so that the accessory 30 can be detached and mounted without the special tool. The user can conveniently detach and relocate the accessory 30 according to working conditions.

In the related art, a mount structure for receiving or connecting the accessory is basically exposed to the user, which causes aesthetic damage in appearance. Meanwhile, considering the harsh working conditions of the tool, the exposed retaining surface will fail under the erosion of oil stains and dust. Thus, a retention failure or an unlocking failure occurs, which is not conducive to the service life and safety of the product. In this example, the second cover 21 is provided to form the accommodation space for accommodating the limiting portion 24 and at least part of the unlocking portion 23, thereby ensuring the service life of the product.

The accessory 30 includes, but is not limited to, a belt clip 35, a screwdriver bit, or a container for storing screws.

In another aspect, the user mounts or replaces different accessories on the handheld power tool according to different needs. For example, the accessory such as the belt clip and a bit holder is mounted on the handheld power tool. When the accessory 30 needs to be replaced or detached, the unlocking portion 23 is triggered to drive the limiting portion 24 to unlock the accessory 30, and the accessory 30 can be removed. In this process, the accessory 30 can be mounted or detached very conveniently without a special tool.

As shown in FIG. 1, in some examples, at least two receiving portions 22 are included. In some examples, when the accessory 30 is, for example, the belt clip, one end of the accessory 30 is inserted into one receiving portion 22, and then the accessory 30 such as the belt clip passes through a belt of a worker so that the handheld power tool is hung around the waist of the worker, freeing the hands of the worker. One end of another accessory 30 is inserted into another receiving portion 22. The at least two receiving portions 22 are provided so that the accessory is convenient to relocate. Different accessories 30 may be configured as needed so that the handheld power tool can be configured with different accessories 30 according to working needs and can well adapt to the working needs.

As shown in FIG. 2, the second cover 21 further includes replaceable decorative covers 212. A decorative cover 212 is mounted at the receiving portion 22. The decorative cover 212 is mounted to the accessory receptacle 20 through the limiting portion 24. When the accessory 30 needs to be mounted, the limiting portion 24 is unlocked by the unlocking portion 23, the decorative cover 212 is removed, and the accessory 30 is mounted. The decorative covers 212 are provided so that the aesthetic of the accessory receptacle 20 can be ensured, and impurities in a working environment can be prevented from entering the accessory receptacle 20.

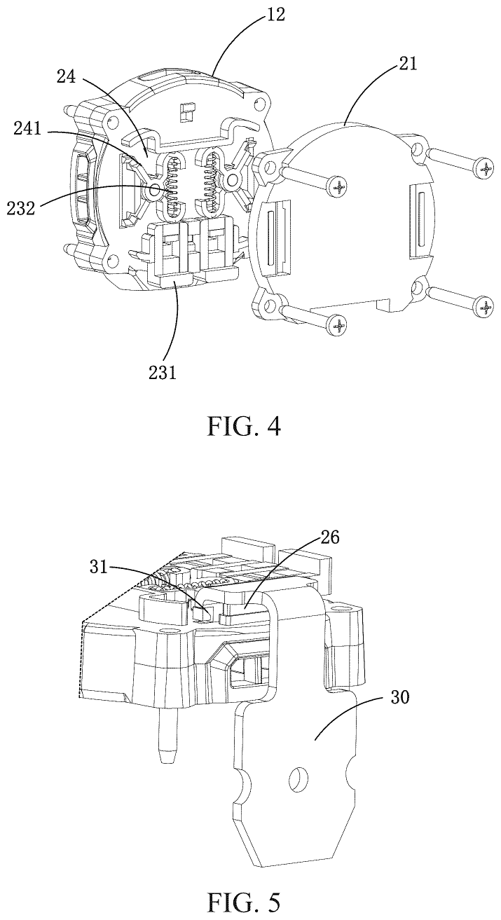

As shown in FIGS. 4 to 7, the unlocking portion 23 includes an operating member 231, and the operating member 231 is formed on or connected to the limiting portion 24. The operating member 231 is movably connected to the second cover 21 and at least partially extends out of the second cover 21. In some examples, the limiting portion 24 includes an X-shaped clamping assembly. The clamping assembly is formed by two V-shaped clips 241 that are rotatably connected through a spindle. The two clips 241 are opposite and form a clamping slot or a structure similar to the clamping slot on a side of the two clips 241 facing the receiving portion 22. The clamping slot or the structure similar to the clamping slot is used for retaining the accessory 30. The accessory 30 is retained in the clamping slot on the left side or the right side of the clips 241. In this example, the accessory 30 is retained in a first clamping slot 245 formed by the clips 241.

Optionally, the operating member 231 is provided with a guide slot 233, a guide block 121 protrudes on a side of the first cover 12 facing the second cover 21, the guide block 121 is disposed in the guide slot 233, part of the operating member 231 is disposed in the second cover 21 and part of the operating member 231 extends out of the second cover 21, and a movement direction of the operating member 231 is limited by the guide block 121. When the accessory 30 is replaced, the operating member 231 only needs to be moved to push a clip 241 of the limiting portion 24 to rotate so that the first clamping slot 245 becomes larger to release the accessory 30 and then the accessory 30 can be removed smoothly. Of course, the guide slot 233 may be defined on the second cover 21 and the guide block 121 may protrude on the operating member 231, which is not limited too much here.

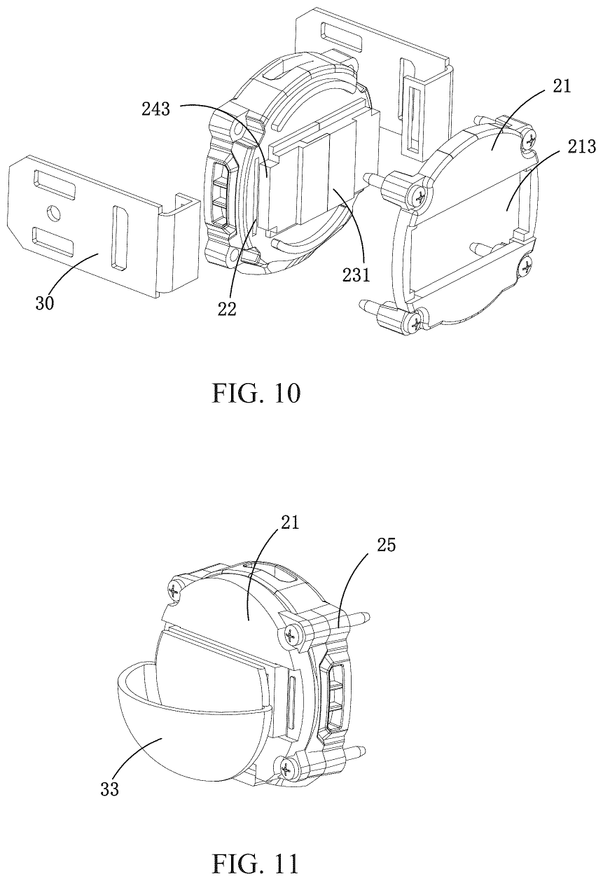

As shown in FIGS. 9 and 10, a slide slot 213 may be defined on the second cover 21, the limiting portion 24 includes a limiting protrusion 243, the limiting protrusion 243 is disposed at an end of the operating member 231, and the operating member 231 is slidably disposed in the slide slot 213. When the accessory 30 needs to be replaced, the operating member 231 is moved to release a limiting connection between the limiting portion 24 and the accessory 30, and then the accessory 30 can be removed.

As shown in FIG. 7, in some examples, the unlocking portion 23 further includes a reset member 232. When the operating member 231 is released, the reset member 232 drives the operating member 231 to reset and provides the limiting portion 24 with the retaining force for the limiting portion 24 to retain the accessory 30. In some examples, the reset member 232 is a compression spring disposed in a second clamping slot 246 formed by the two clips 241. In this example, the two clips 241 form the first clamping slot 245 and the second clamping slot 246 on two sides of the spindle, where the second clamping slot 246 for accommodating the reset member 232 is disposed on a side facing away from the receiving portion 22, and the first clamping slot 245 for retaining the accessory 30 is disposed on a side facing the receiving portion 22. Two ends of the compression spring abut against two edges of the two clips 241 on the same side so that two edges of the two clips 241 closer to the receiving portion 22 have a tendency to approach each other to clamp the accessory 30 in the first clamping slot 245 and maintain the retaining force on the accessory 30. When the accessory 30 is unlocked, the operating member 231 is pushed to move, and the operating member 231 pushes one clip 241 to rotate relative to the other clip 241 and compress the compression spring so that the first clamping slot 245 that clamps the accessory 30 becomes larger, and the accessory 30 is removed. After the accessory 30 is removed, the operating member 231 is released, and the compression spring pushes the operating member 231 to reset and drives the clip 241 to reset under the action of an elastic restoring force, and the first clamping slot 245 is restored to a limiting and clamping state.

In some examples, the reset member 232 is the compression spring, the reset member 232 is disposed in the slide slot 213 of the second cover 21, an end of the reset member 232 abuts against the operating member 231, and the other end of the reset member 232 abuts against the bottom of the slide slot 213. When the operating member 231 unlocks the limiting portion 24, the operating member 231 is pushed to compress the reset member 232, the operating member 231 is released from limiting the accessory 30, and the accessory 30 is removed. Then, the operating member 231 is released, the reset member 232 pushes the operating member 231 to reset under the action of the elastic restoring force, and the limiting protrusion 243 at an end of the operating member 231 facing away from the reset member 232 resets. If two operating members 231 are arranged in the slide slot 213, the reset member 232 may be disposed between the two operating members 231. When any operating member 231 is pushed to move for unlocking, the reset member 232 is compressed. After the accessory 30 is replaced, the reset member 232 can reset the operating member 231 so that the limiting portion 24 maintains the retaining force on the accessory 30.

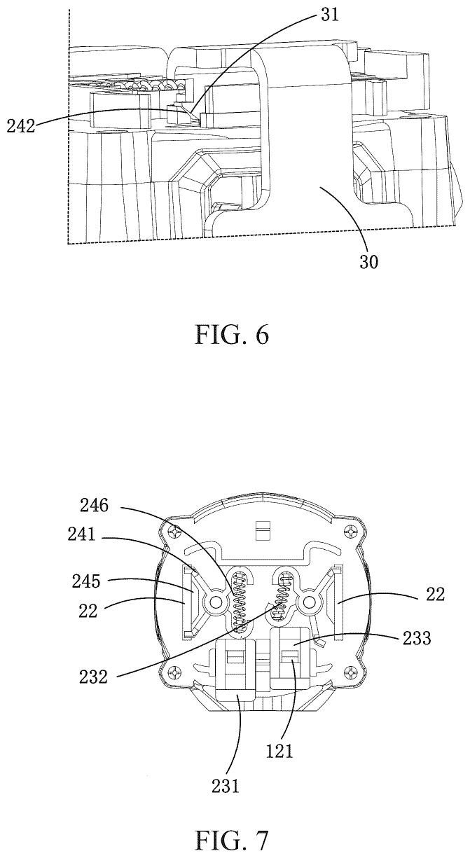

As shown in FIGS. 5 and 6, in some examples, the accessory 30 is driven to move in a preset direction and a first surface 31 of the accessory 30 pushes a second surface 242 of the limiting portion 24 so that the limiting portion 24 moves in a direction to release the retaining force on the accessory 30. In some examples, the first surface 31 and the second surface 242 are both inclined surfaces. The first surface 31 and the second surface 242 slide relative to each other so that when the accessory 30 is mounted and inserted, the first surface 31 presses the second surface 242, and the limiting portion 24 moves in the direction to release the retaining force on the accessory 30. After the accessory 30 is mounted in place, the first surface 31 is disengaged from the second surface 242, and the limiting portion 24 limits, clamps and fixes the accessory 30 under the action of the reset member 232, thereby mounting and fixing the accessory 30 in the accessory receptacle 20. In some examples, the first surface 31 or the second surface 242 may be provided alone, which is not limited too much here.

In some examples, the accessory receptacle 20 further includes a limiting pad 26 configured to fill a gap between the accessory 30 and one of the receiving portion 22 or the limiting portion 24. In some examples, the limiting pad 26 is made of an elastic or soft material. In this example, the limiting pad 26 is made of rubber. The limiting pad 26 is provided so that it can be ensured that the accessory 30 will not shake after being mounted.

In some examples, the limiting portion 24 extends or is embedded into the accessory 30 to retain the accessory 30. The accessory 30 is provided with an insertion slot, and the limiting portion 24 extends or is embedded into the insertion slot of the accessory 30 so that the accessory 30 can be fixed. In this manner, the accessory 30 is conveniently fixed by the limiting portion 24, and the structure is simple.

As shown in FIG. 13, in some examples, the accessory 30 includes the belt clip 35 for hanging the handheld power tool. One end of the belt clip 35 is connected to the receiving portion 22, the other end of the belt clip 35 is a quick-hanging portion 351 with a receiving slot, and the quick-hanging portion 351 may be engaged with a belt 4 so that the handheld power tool is fixed to the belt 4 of the worker. In some examples, the handheld power tool may be hung, through the belt clip 35, on some protruding parts (such as nails) near some working positions. With the belt clip 35, the handheld power tool is conveniently and quickly placed at a proper position in a working region, thereby freeing the hands of the worker.

As shown in FIG. 11, in some examples, the accessory 30 includes a first connector 32 and a storage member, and the storage member is a container 33. The other end of the belt clip 35 is a storage member, and the storage member may be used for placing the accessory 30 according to the working needs, such as the nail, a nut, or a drill bit. The storage member is provided so that the worker can conveniently store and take small parts needed for work.

In some examples, an opening of the container 33 always faces upwards. With the above arrangement, small parts are convenient to store and take, and when the worker is working, the container 33 will not overturn and the small parts will not be scattered.

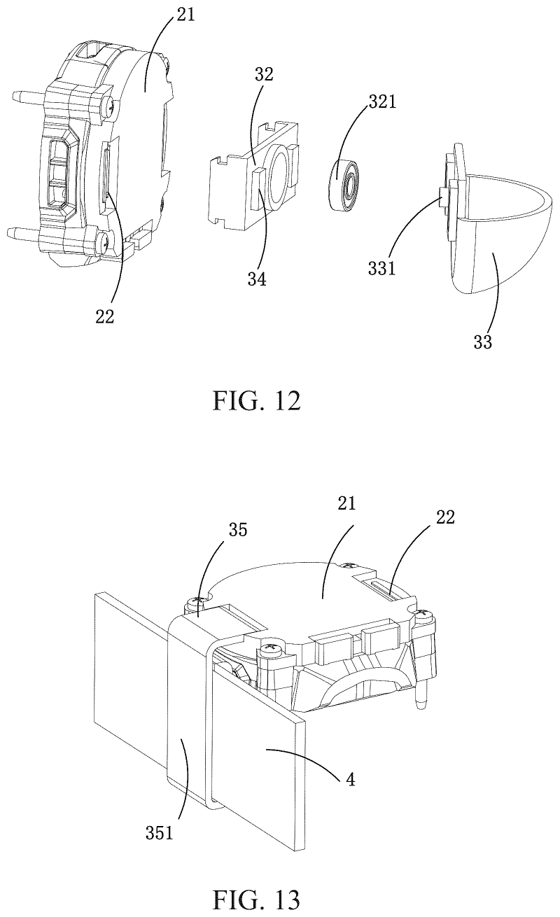

As shown in FIG. 12, in some examples, the container 33 is rotatably disposed on the first connector 32, and the opening of the container 33 always faces upwards under the action of its own gravity. The first connector 32 is connected to the accessory receptacle 20, a bearing 321 is fixedly mounted on the first connector 32, a spindle 331 is provided at an end of the container 33, and the spindle 331 is connected to an inner ring of the bearing 321. It is ensured under the action of the gravity of the container 33 that the opening of the container 33 faces upwards. In some examples, a counterweight block may be disposed at the lower end of the container 33 so that the center of gravity of the container 33 is always located below the spindle 331. To prevent small parts from falling, mounting grooves are provided on a side of the container 33 facing the first connector 32, and magnets 34 are provided in the mounting grooves so that small iron parts can be attracted by the magnets 34.

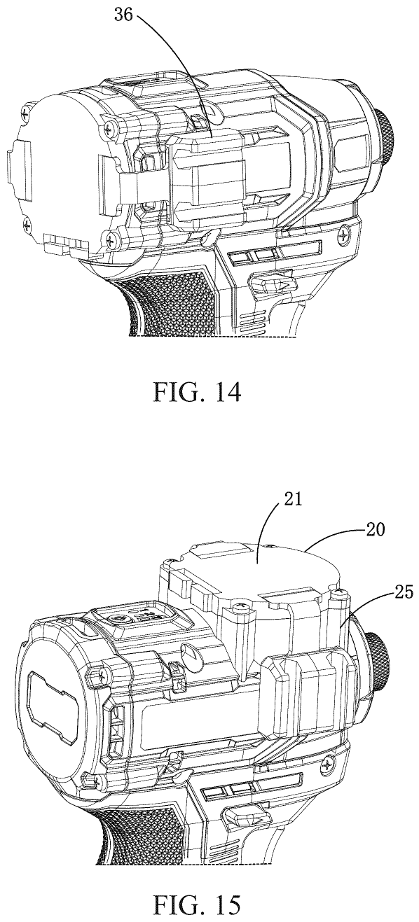

As shown in FIG. 14, in some examples, the accessory 30 includes the belt clip 35 and a storage member, and the storage member is a bit retaining structure 36. One end of the belt clip 35 is connected to the accessory receptacle 20 of the handheld power tool, and the other end of the belt clip 35 is the storage member. The storage member may be used for placing screwdriver bits of different models according to the working needs, facilitating the use and storage by the worker.

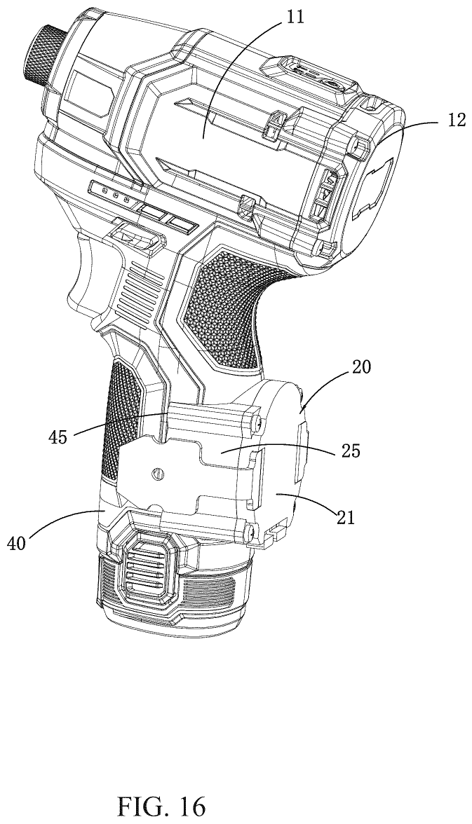

As shown in FIGS. 15 and 16, an accessory receptacle is further provided, which is used for detachably connecting an accessory 30 of a handheld power tool. The accessory receptacle includes a receiving portion 22, a limiting portion 24, an unlocking portion 23, a retaining cover 25, and a second cover 21. The receiving portion 22 is used for receiving at least one accessory 30. The limiting portion 24 is used for retaining the accessory 30 in the receiving portion 22. The unlocking portion 23 is triggered to drive the limiting portion 24 to release a retaining force on the accessory 30. The retaining cover 25 is disposed at the rear end of a housing of the handheld power tool. The second cover 21 is connected to the outer side of the retaining cover 25, the second cover 21 forms an accommodation space with the retaining cover 25, and the accommodation space is configured to at least partially accommodate the receiving portion 22, the limiting portion 24, and the unlocking portion 23. At least one of the retaining cover 25 and the second cover 21 is detachably connected to the rear end of the housing of the handheld power tool.

In some examples, an accessory receptacle 20 is further provided. The accessory receptacle 20 is used for detachably connecting an accessory 30 of a handheld power tool. The accessory receptacle 20 includes a receiving portion 22, a limiting portion 24, an unlocking portion 23, a retaining cover 25, and a second cover 21. The receiving portion 22 is used for receiving at least one accessory 30 of the handheld power tool. The limiting portion 24 is used for retaining the accessory 30 in the receiving portion 22. The unlocking portion 23 is triggered to drive the limiting portion 24 to release a retaining force on the accessory 30.

In some examples, the accessory receptacle 20 further includes the retaining cover 25, and the retaining cover 25 is formed on or connected to a housing 10 of the handheld power tool. The second cover 21 is connected to the outer side of the retaining cover 25, the second cover 21 forms an accommodation space with the retaining cover, and the accommodation space is configured to at least partially accommodate the receiving portion 22, the limiting portion 24, and the unlocking portion 23. The accessory receptacle 20 is disposed on the handheld power tool. When the accessory 30 needs to be replaced or detached, the unlocking portion 23 is triggered to drive the limiting portion 24 to unlock the accessory 30, and the accessory 30 can be removed. In this process, the accessory 30 can be mounted or detached very conveniently without a special tool.

As shown in FIG. 1, the retaining cover 25 of the accessory receptacle 20 is formed on the first cover 12. Optionally, the retaining cover 25 is integrated with the first cover 12. The retaining cover 25 is a structure on the outer side of the first cover 12 and for connecting or retaining at least one of the receiving portion 22, the limiting portion 24, and the unlocking portion 23. As shown in FIG. 15, as another example of the accessory receptacle 20, the retaining cover 25 of the accessory receptacle 20 is a separate component connected to the outer side of the housing. The retaining cover 25 is separately provided and used for fixing or retaining at least one of the receiving portion 22, the limiting portion 24, and the unlocking portion 23. The retaining cover 25 is separately provided so that the accessory receptacle 20 can be used as an independent integral component. In one aspect, the accessory receptacle 20, as an optionally configured part, can be sold or configured separately from the screwdriver 100 and is convenient to maintain and replace. In the other aspect, the accessory receptacle is universally used in existing products with relatively small modifications to the existing products or product platforms.

In some examples, the second cover 21 is connected to the retaining cover 25 by a fastener 211. The fastener 211 includes, but is not limited to, a threaded fastener, mutually mating mechanical connections such as a snap or a snap button, and a latch structure. The fastener 211 maintains a connection between the second cover 21 and the retaining cover 25. To ensure the stability of the connection between the second cover 21 and the retaining cover 25, multiple fasteners 211 may be used. No excessive limitations are made here.

As shown in FIGS. 15 and 16, in some examples, the accessory receptacle 20 is detachably mounted on the upper side, left side, or right side of the housing 10 of the handheld power tool. In some examples, the accessory receptacle 20 is detachably mounted on a power connection portion 40 or a grip 45. The accessory receptacle 20 may be arranged according to an application scenario of the handheld power tool and use habits of the worker.

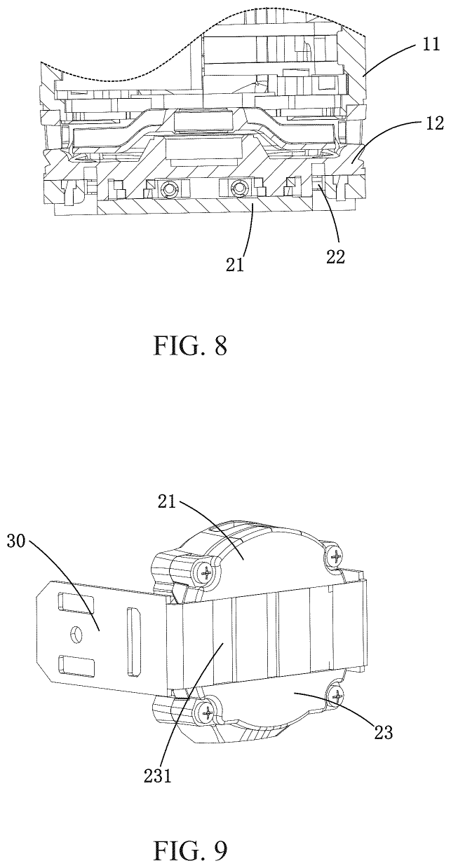

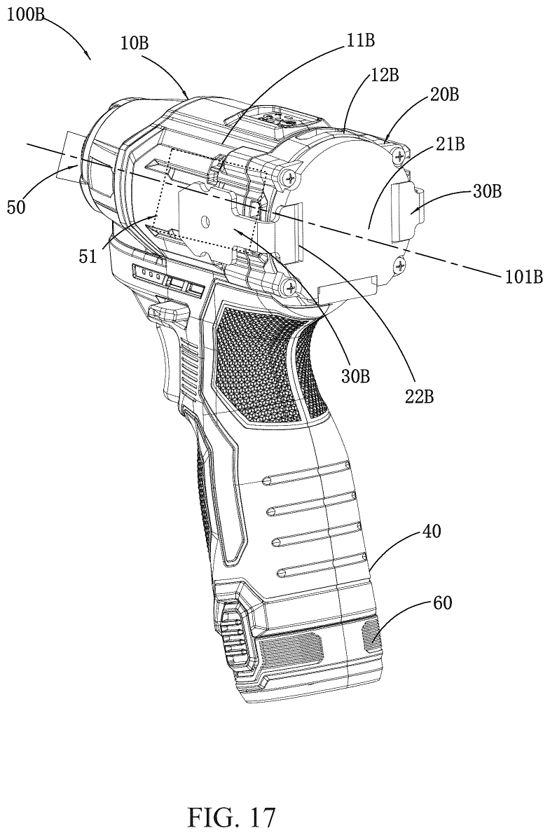

FIGS. 17 to 23 show a handheld power tool 100B according to another example. The handheld power tool 100B is similar to the handheld power tool 100 described above with reference to FIGS. 1 to 16. Therefore, features and elements of the handheld power tool 100B corresponding to those of the handheld power tool 100 are given similar reference numerals followed by the letter “B”. In addition, the following description mainly focuses on differences between the handheld power tool 100B and the handheld power tool 100.

The handheld power tool 100B further includes an accessory receptacle 20B for detachably connecting an accessory 30B of the handheld power tool. The accessory receptacle 20B includes a receiving portion 22B, a limiting portion 24B, and an unlocking portion 23B. The receiving portion 22B is provided with a receiving groove mating with the accessory 30B and used for receiving at least one accessory 30B. The limiting portion 24B exerts a retaining force on the accessory 30B to retain the accessory 30B in the receiving portion 22B. The unlocking portion 23B is connected to the limiting portion 24B. The unlocking portion 23B rotates around a third axis 103B upon receiving a trigger force to drive the limiting portion 24B to release the retaining force on the accessory 30B. In this example, the third axis 103B is parallel to but does not coincide with a first axis 101B. In some examples, the third axis 103B intersects the first axis 101B.

The limiting portion 24B can be unlocked only when the unlocking portion 23B is rotated. Therefore, the unlocking portion 23B is not easily unlocked by accident unless a user rotates the unlocking portion 23B, thereby preventing the accessory 30B from being separated from the handheld power tool due to an accidental touch of the user.

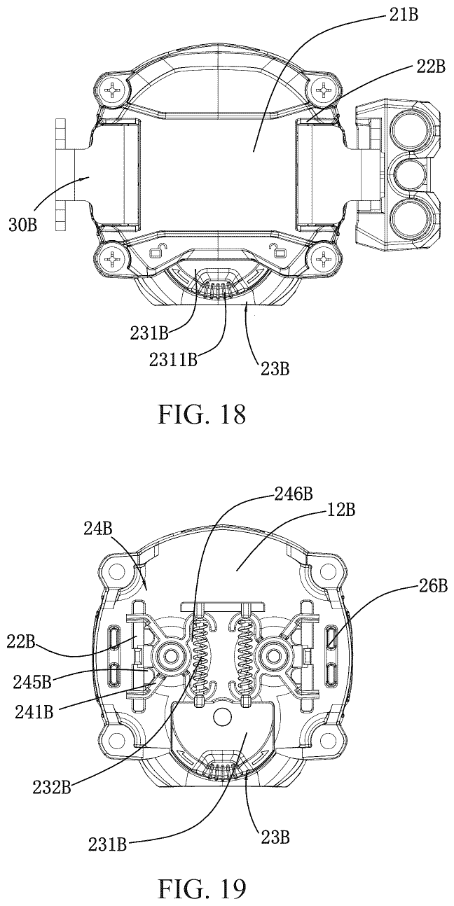

As shown in FIGS. 18 to 21, in some examples, the accessory receptacle 20B includes at least two receiving portions 22B to receive at least two accessories 30B. The accessory receptacle 20B is provided with multiple receiving portions 22B so that different accessories 30B can be configured according to needs of the user. When the accessory 30B is a belt clip, one end of the belt clip is inserted into one receiving portion 22B, the belt clip passes through a belt of a worker, and the other end of the belt clip is inserted into another receiving portion 22B so that the handheld power tool is hung around the waist of the worker, freeing the hands of the worker. The at least two receiving portions 22B are provided so that different accessories 30B can be configured as needed. The belt clip is inserted into one receiving portion 22B, and a container for storing screwdriver bits or screws is inserted into another receiving portion 22B so that the handheld power tool can be hung through the belt clip, and the screwdriver bits or the screws are convenient to carry, thereby well adapting to working needs.

In some examples, one unlocking portion 23B is provided, the unlocking portion 23B includes multiple positions for unlocking respective accessories 30, and the unlocking portion 23B is operable to switch between the multiple positions to release the retaining force on the corresponding accessory 30B. In this example, the accessory receptacle 20B includes the at least two receiving portions 22B. When one unlocking portion 23B is configured, it is set that the unlocking portion 23B has at least two positions. The unlocking portion 23B is rotated to the corresponding position so that the accessory 30B can be unlocked from the limiting portion 24B at the corresponding receiving portion 22B. Moreover, only one unlocking portion 23B is disposed so that with the unlocking requirement satisfied, the number of parts used is reduced and the accessory receptacle 20B is simple in structure.

In some examples, the unlocking portion 23B is swung around the third axis 103B. The unlocking portion 23B is swung by different angles to correspond to different unlocking positions so that the retaining force on the corresponding accessory 30B can be released.

As shown in FIG. 17, in some examples, a housing 10B includes a first housing 11B and a first cover 12B, where the first housing 11B extends substantially along the first axis 101B. The first cover 12B is formed at or connected to an end of the first housing 11B facing away from an output portion 50, and the first cover 12B extends along a direction intersecting the first axis 101B. The first cover 12B is formed at or connected to the end of the first housing 11B facing away from the output portion 50. In this example, the first cover 12B is a rear cover of the housing 10B. A left housing and a right housing are assembled to form an accommodation space whose rear portion is configured with an opening, and the first cover 12B is connected to the first housing 11B and covers the opening of the rear portion. In another example, the first cover 12B is formed on the left housing and the right housing, that is to say, a rear wall portion of the left housing and a rear wall portion of the right housing constitute the first cover 12B.

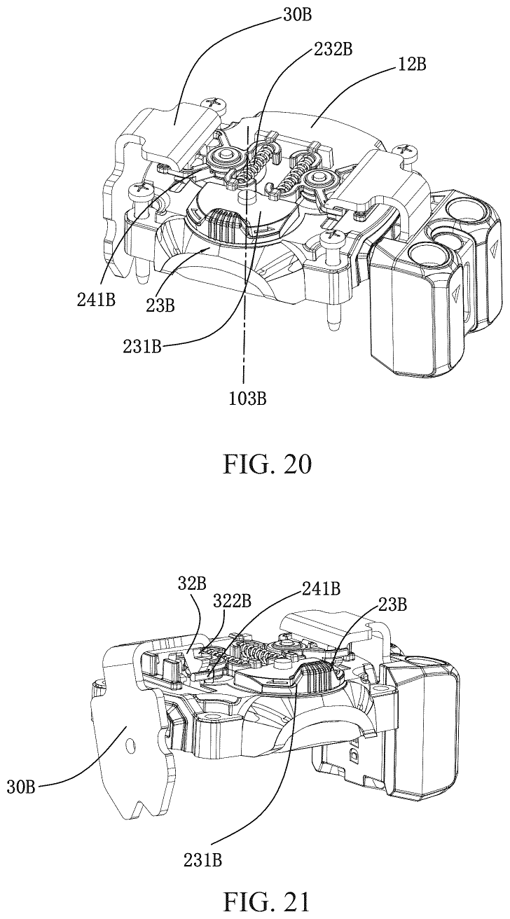

As shown in FIGS. 19 and 20, the unlocking portion 23B is rotatably connected to the first cover 12B around the third axis 103B. When the accessory 30B is unlocked by the unlocking portion 23B, the unlocking portion 23B only needs to be rotated to an unlocking position.

In some examples, the accessory receptacle 20B further includes a second cover 21B, and the second cover 21B forms an accommodation space with the first cover 12B. The accommodation space is configured to at least partially accommodate the receiving portion 22B, the limiting portion 24B, and the unlocking portion 23B. With the above arrangement, the receiving portion 22B, the limiting portion 24B, and the unlocking portion 23B are convenient to mount. In the above manner, the accessory receptacle 20B can be designed as an independent unit, and the accessory receptacle 20B is detachably disposed on the handheld power tool. In actual use, different accessory receptacles 20B may be configured according to different working occasions so that requirements in various working occasions can be flexibly satisfied. Moreover, the first cover 12B and the second cover 21B form a relatively closed accommodation space so that the limiting portion 24B and the unlocking portion 23B can be protected.

As shown in FIGS. 18 to 21, the unlocking portion 23B includes an operating member 231B, the operating member 231B is formed on or connected to the limiting portion 24B, the operating member 231B is movably connected to the second cover 21B, and the operating member 231B at least partially extends out of the second cover 21B. In some examples, the limiting portion 24B includes an X-shaped clamping assembly. The clamping assembly is formed by two V-shaped clips 241B that are rotatably connected through a spindle. The two clips 241B are opposite and form a first clamping slot 245B or a structure similar to the clamping slot on a side of the two clips 241B facing the receiving portion 22B. The first clamping slot 245B or the structure similar to the clamping slot is used for retaining the accessory 30. The accessory 30B is retained in the first clamping slot 245B of the clips 241B.

In some examples, the unlocking portion 23B is driven by the limiting portion 24B to reset. The unlocking portion 23B includes a reset member 232B. When the operating member 231B is released, the reset member 232B can drive the operating member 231B of the unlocking portion 23B to reset and provide the limiting portion 24B with the retaining force for the limiting portion 24B to retain the accessory 30B. In some examples, the reset member 232B is a compression spring disposed in a second clamping slot 246B formed by the two clips 241B. In this example, the second clamping slot 246B for accommodating the reset member 232B is disposed on a side facing away from the receiving portion 22B, and the first clamping slot 245B for retaining the accessory 30B is disposed on a side facing the receiving portion 22B. Two ends of the compression spring abut against two edges of the two clips 241B on the same side so that two edges of the two clips 241B closer to the receiving portion 22B have a tendency to approach each other to clamp the accessory 30B in the first clamping slot 245B and maintain the retaining force on the accessory 30B.

When the accessory 30B is unlocked, the operating member 231B is operated to rotate around the third axis 103B, and the operating member 231B pushes one clip 241B to rotate relative to the other clip 241B and compress the compression spring so that the first clamping slot 245B that limits and clamps the accessory 30B becomes larger, and the accessory 30B is removed. After the accessory 30B is removed, the operating member 231B is released, and the compression spring pushes the operating member 231B to reset and drives the clip 241B to reset under the action of an elastic restoring force, and the first clamping slot 245B is restored to a limiting and clamping state. In other examples, a torsion spring may be used as the reset member 232B. The torsion spring is disposed on the operating member 231B, one end of the torsion spring is connected to the operating member 231B, and the other end of the torsion spring is connected to the first cover 12B or the second cover 21B. During rotation of the operating member 231B, the torsion spring stores energy. After the operating member 231B is released, the operating member 231B automatically resets under the action of the torsion spring.

As shown in FIG. 18, the unlocking position of the unlocking portion 23B corresponds to the position of the accessory 30B. During an unlocking operation, the user rotates the unlocking portion 23B in a corresponding direction according to the accessory 30B to be unlocked. For example, if the accessory 30B on the left side needs to be unlocked, the operating member 231B of the unlocking portion 23B only needs to be rotated to the left side; if the accessory 30B on the right side needs to be unlocked, the operating member 231B of the unlocking portion 23B only needs to be rotated to the right side. A position to which the operating member 231B resets is a locking position. When the operating member 231B is at the locking position, the accessory 30B is limited by the limiting portion 24B in the accessory receptacle 20B. In this example, the locking position of the operating member 231B is an initial position, that is to say, the operating member 231B always remains at the locking position without being driven by an external force. The above arrangement facilitates the operation of the user.

An anti-slip pattern 2311B is provided on a surface of the operating member 231B. When the user rotates the operating member 231B, the anti-slip pattern 2311B can increase friction between the operating member 231B and a finger of the user, facilitating the control of rotation of the operating member 231B.

In some examples, the accessory receptacle 20B is detachably mounted on the upper side, left side, or right side of the housing 10B of the handheld power tool. In some examples, the accessory receptacle 20B is detachably mounted on a power connection portion 40 or a grip 45. The accessory receptacle 20B may be arranged according to an application scenario of the handheld power tool and use habits of the worker.

The accessory 30B is mounted to and detached from the handheld power tool by the process described below.

The accessory 30B is mounted: a side of a first connector 32B of the accessory 30B is inserted into the receiving portion 22B and in contact with the limiting portion 24B. Then, the first connector 32B is rotated and pressed so that the other side of the first connector 32B is also inserted into the receiving portion 22B. One clip 241B rotates so that the first clamping slot 245B becomes larger until the first connector 32B is in place. The clip 241B is reset under the action of the reset member 232B and is connected to the first connector 32B in a limiting manner so that the accessory 30B is retained in the receiving portion 22B and locked.

The accessory 30B is detached: the operating member 231B of the unlocking portion 23B is rotated in a direction towards the accessory 30B to be detached. The operating member 231B abuts against one clip 241B of the limiting portion 24B and pushes the clip 241B to rotate so that the first clamping slot 245B that clamps the accessory 30B becomes larger. Thus, with a side of the first connector 32B facing away from the operating member 231B as a fulcrum, the first connector 32B of the accessory 30B is rotated and the accessory 30B can be removed.

The present application further provides a handheld power tool including a motor 51, an output portion 50, a housing, and an accessory receptacle 20B.

The motor 51 includes a drive shaft rotating around a drive axis; the output portion 50 is driven by the motor 51 to output power; and a housing 10B accommodates the motor 51. The accessory receptacle 20B is used for detachably connecting an accessory 30B of the handheld power tool. The accessory receptacle 20B includes a receiving portion 22B, a limiting portion 24B, and an unlocking portion 23B. The receiving portion 22B receives at least two accessories 30B. The limiting portion 24B retains the accessory 30B in the receiving portion 22B. The unlocking portion 23B is connected to the limiting portion 24B. One unlocking portion 23B is provided, and the unlocking portion 23B is operated to move between multiple positions. When the unlocking portion 23B moves to an unlocking position among the multiple positions, the unlocking portion 23B drives the limiting portion 24B to release a retaining force on the accessory 30B. When the accessory 30B needs to be unlocked and removed, the unlocking portion 23B only needs to be moved to the corresponding unlocking position and the accessory 30B can be removed.

As shown in FIGS. 17 to 23, the present application provides a handheld power tool. The handheld power tool includes a motor 51, an output portion 50, a housing 10B, and an accessory receptacle 20B. The motor 51 includes a drive shaft rotating around a drive axis; the output portion 50 is driven by the motor 51 to output power; and the housing 10B accommodates the motor 51.

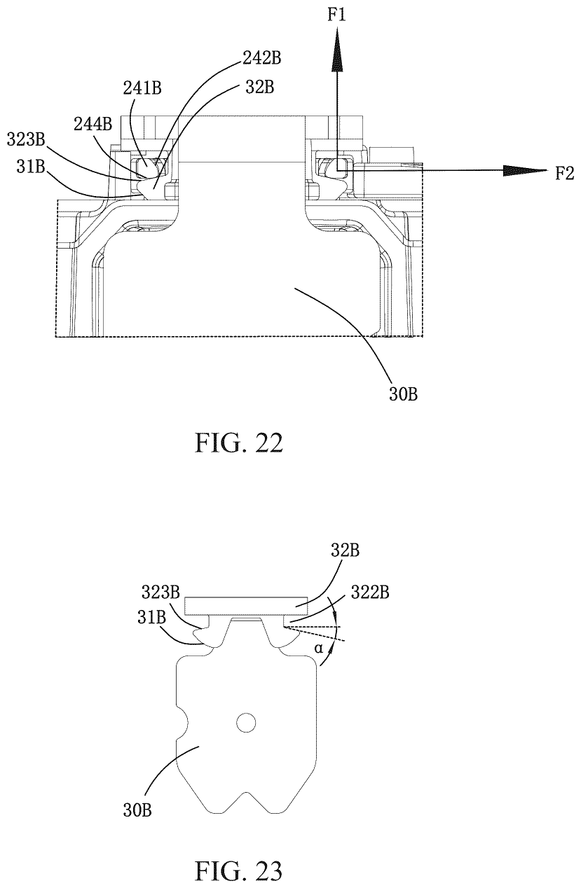

As shown in FIGS. 22 and 23, the accessory receptacle 20B is used for detachably connecting an accessory 30B of the handheld power tool, and the accessory receptacle 20B includes a receiving portion 22B and a limiting portion 24B. The receiving portion 22B is provided with a receiving groove mating with the accessory 30B and used for receiving at least one accessory 30B. The limiting portion 24B exerts a retaining force on the accessory 30B to retain the accessory 30B in the receiving portion 22B. The limiting portion 24B includes a limiting surface 244B, and the accessory 30B includes a stop surface 323B. When the accessory 30B is retained in the receiving groove, the limiting surface 244B is in contact with the stop surface 323B to prevent a displacement of the accessory 30B along a first direction F1. The angle α between a length extension direction of the stop surface 323B and a second direction F2 is less than or equal to 30°, the second direction F2 is perpendicular to the first direction F1, and the second direction F2 and the length extension direction of the stop surface 323B are in the same plane.

The limiting surface 244B of the limiting portion 24B is in contact with the stop surface 323B to prevent the displacement of the accessory 30B along the first direction F1 so that a gap between the accessory 30B and the limiting portion 24B is reduced, the shaking of the accessory 30B is reduced, and the accessory 30B conveniently mates with the limiting portion 24B to lock the accessory 30B on the handheld power tool. The angle α between the length extension direction of the stop surface 323B and the first direction F2 perpendicular to the first direction F1 is less than or equal to 30° so that a self-locking angle is formed at the stop surface 323B, the accessory 30B can be prevented from squeezing away the limiting portion 24B and being unlocked when subjected to a force, and the accessory 30B can be prevented from being separated from the handheld power tool.

In some examples, the angle α between the length extension direction of the stop surface 323B and the first direction F2 is less than or equal to 25°. In some examples, the angle α between the length extension direction of the stop surface 323B and the first direction F2 is less than or equal to 20°. In some examples, the angle α between the length extension direction of the stop surface 323B and the first direction F2 is less than or equal to 18°. As shown in FIGS. 19 and 22, in some examples, the accessory 30B includes a first surface 31B, and the limiting portion 24B includes a second surface 242B. The accessory 30B is driven to move in a preset direction and the first surface 31B of the accessory 30B can push the second surface 242B of the limiting portion 24B so that the limiting portion 24B moves in a direction to release the retaining force on the accessory 30B. The first surface 31B of the accessory 30B is connected to the stop surface 323B so that a triangular protrusion is formed on a side of a first connector 32B of the accessory 30B. The first surface 31B and the second surface 242B are both inclined surfaces. When the first connector 32B of the accessory 30B is inserted into the receiving portion 22B, the first surface 31B and the second surface 242B slide relative to each other and the first surface 31B presses the second surface 242B so that the limiting portion 24B moves in the direction to release the retaining force on the accessory 30B. After the accessory 30B is mounted in place, the first surface 31B is disengaged from the second surface 242B, the limiting portion 24B is reset, and the limiting surface 244B of the limiting portion 24B is in contact with the stop surface 323B of the accessory 30B to prevent the displacement of the accessory 30B along the first direction F1 so that the accessory 30B is connected and fixed in a limiting manner, thereby mounting and fixing the accessory 30B in the accessory receptacle 20B. In some examples, the first surface 31B or the second surface 242B may be provided alone, which is not limited too much here.

An insertion slot 322B is formed on a side of the accessory 30B. The insertion slot 322B is used for accommodating the limiting surface 244B of the limiting portion 24B. A wall surface on a side of the insertion slot 322B is the stop surface 323B. The insertion slot 322B is provided to ensure that the limiting portion 24B mates with the insertion slot 322B so that the accessory 30B is locked. When the limiting portion 24B is not unlocked, the accessory 30B cannot be pulled out even with a relatively large pulling force.

As shown in FIGS. 18 and 23, in some examples, the limiting portion 24B extends or is embedded into the accessory 30B to retain the accessory 30B. The accessory 30B has the insertion slot 322B, and the limiting portion 24B extends or is embedded into the insertion slot 322B of the accessory 30B so that the accessory 30B can be stably fixed. In this manner, the accessory 30B is conveniently fixed by the limiting portion 24B, and the structure is simple.

As shown in FIG. 19, the handheld power tool further includes a limiting pad 26B configured to fill a gap between the accessory 30B and one of the receiving portion 22B or the limiting portion 24B. In some examples, the limiting pad 26B is made of an elastic or soft material. In this example, the limiting pad 26B is made of rubber. The limiting pad 26B is provided so that it can be ensured that the accessory 30B will not shake relative to the receiving portion 22B after mounting, thereby ensuring the stability of the accessory 30B after mounting.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A handheld power tool, comprising:
a motor;
an output portion driven by the motor to output power;
a housing for accommodating the motor, the housing comprising a first housing extending substantially along a first axis and a first cover formed at or connected to an end of the first housing facing away from the output portion and extending along a direction intersecting the first axis; and
an accessory receptacle for detachably connecting an accessory of the handheld power tool, the accessory receptacle comprising a receiving portion for receiving at least one accessory, a limiting portion for retaining the accessory in the receiving portion, an unlocking portion triggered to drive the limiting portion to release a retaining force on the accessory, and a second cover forming an accommodation space with the first cover, wherein the accommodation space is configured to at least partially accommodate the receiving portion, the limiting portion, and the unlocking portion.

2. The handheld power tool according to claim 1, wherein at least two receiving portions are provided.

3. The handheld power tool according to claim 1, wherein the unlocking portion comprises an operating member, and the operating member is formed on or connected to the limiting portion, is movably connected to the second cover, and at least partially extends out of the second cover.

4. The handheld power tool according to claim 3, wherein the unlocking portion further comprises a reset member, and, when the operating member is released, the reset member is able to drive the operating member to reset and provide the limiting portion with the retaining force for the limiting portion to retain the accessory.

5. The handheld power tool according to claim 1, wherein the accessory is driven to move in a preset direction and a first surface of the accessory pushes a second surface of the limiting portion so that the limiting portion moves in a direction to release the retaining force on the accessory.

6. The handheld power tool according to claim 1, wherein the accessory receptacle further comprises a limiting pad configured to fill a gap between the accessory and one of the receiving portion or the limiting portion.

7. The handheld power tool according to claim 1, wherein the limiting portion extends or is embedded into the accessory to retain the accessory.

8. The handheld power tool according to claim 1, wherein the accessory comprises a belt clip for hanging the handheld power tool.

9. The handheld power tool according to claim 1, wherein the accessory comprises a belt clip and a storage member, and the storage member is a bit retaining structure.

10. The handheld power tool according to claim 1, wherein the accessory comprises a first connector and a storage member, and the storage member is a container.

11. The handheld power tool according to claim 10, wherein an opening of the container always faces upwards.

12. The handheld power tool according to claim 11, wherein the container is rotatably disposed on the first connector, and the opening of the container always faces upwards under the action of gravity.

13. The handheld power tool according to claim 1, wherein the unlocking portion is connected to the limiting portion, and the unlocking portion rotates upon receiving a trigger force to drive the limiting portion to release the retaining force on the accessory.

14. The handheld power tool according to claim 1, wherein one unlocking portion is provided, the unlocking portion comprises a plurality of positions for unlocking respective accessories, and the unlocking portion is operable to switch between the plurality of positions to release the retaining force on a corresponding accessory.

15. The handheld power tool according to claim 1, wherein the limiting portion comprises a limiting surface, the accessory comprises a stop surface, when the accessory is retained in the receiving portion, the limiting surface is in contact with the stop surface to prevent a displacement of the accessory along a first direction, an angle α between a length extension direction of the stop surface and a second direction is less than or equal to 30°, the second direction is perpendicular to the first direction, and the second direction and the length extension direction of the stop surface are in the same plane.

16. A handheld power tool, comprising:
a motor;
an output portion driven by the motor to output power;
a housing comprising a first housing and a power connection portion, wherein the first housing accommodates at least the motor, the power connection portion receives at least part of a power supply, and the power supply supplies power to at least the motor; and
an accessory receptacle for detachably connecting an accessory of the handheld power tool, the accessory receptacle comprising a receiving portion for receiving at least one accessory of the handheld power tool, a limiting portion for retaining the accessory of the handheld power tool in the receiving portion, and a second cover fixed on an outer side of the housing by a fastener, wherein the second cover forms an accommodation space with the housing, and the accommodation space is configured to at least partially accommodate the receiving portion and the limiting portion.

17. An accessory receptacle for detachably connecting an accessory of a handheld power tool, the accessory receptacle comprising:
a receiving portion for receiving at least one accessory of the handheld power tool;
a limiting portion for retaining the accessory in the receiving portion;
an unlocking portion triggered to drive the limiting portion to release a retaining force on the accessory;
a retaining cover formed on or connected to a housing of the handheld power tool; and
a cover connected to an outer side of the retaining cover, wherein the cover forms an accommodation space with the retaining cover, and the accommodation space is configured to at least partially accommodate the receiving portion, the limiting portion, and the unlocking portion.

18. The accessory receptacle according to claim 17, wherein the cover is connected to the retaining cover by a fastener.

19. The accessory receptacle according to claim 17, wherein the unlocking portion is connected to the limiting portion, and the unlocking portion rotates upon receiving a trigger force to drive the limiting portion to release the retaining force on the accessory.

20. The accessory receptacle according to claim 17, wherein the limiting portion comprises a limiting surface, the accessory comprises a stop surface, and when the accessory is retained in the receiving portion, the limiting surface is in contact with the stop surface to prevent a displacement of the accessory along a first direction, wherein an angle α between a length extension direction of the stop surface and a second direction is less than or equal to 30°, the second direction is perpendicular to the first direction, and the second direction and the length extension direction of the stop surface are in the same plane.
